(19) United States
(12) Patent Application Publication
(10) Pub. No.: US 2023/0400189 A1
(43) Pub. Date: Dec. 14, 2023

(54) DETACHABLE AND INTERCHANGEABLE APPLIANCE HANDLE

(71) Applicant: WHIRLPOOL CORPORATION, Benton Harbor, MI (US)

(72) Inventors: Tushar A. KALBANDE, Pune (IN); Sarang H. LOKAKSHA, Pune (IN); Pallavi Baburao NEVAGE, Pune (IN); Yogesh V. SONONE, Pune (IN)

(21) Appl. No.: 17/838,950

(22) Filed: Jun. 13, 2022

(51) Int. Cl. F24C 15/02

(52) U.S. Cl. CPC F24C 15/024

(57) ABSTRACT

A handle assembly for an appliance door may include a handle having at least one attachment mechanism extending from a spacer on an unexposed side of the handle, the attachment mechanism including a ball arranged on a post, the post being received and fixed to the spacer, and a socket arranged on the appliance door and configured to receive the ball to selectively secure the handle to an appliance frame.

### TECHNICAL FIELD

Disclosed herein are systems and methods for a detachable and interchangeable appliance handle.

### BACKGROUND

Appliances, specifically ovens, include handles to allow a user to open and close the door of the appliance. Often times the appliance door may be shipped with the handle installed, or if uninstalled, requiring the user to install the handle, often via screws. However, should the user desire a different handle, either in style, color, etc., it is very difficult to change out the handle once the handle has been installed.

### SUMMARY

A handle assembly for an appliance door may include a handle having at least one attachment mechanism extending from a spacer on an unexposed side of the handle, the attachment mechanism including a ball arranged on a post, the post being received and fixed to the spacer, and a socket arranged on the appliance door and configured to receive the ball to selectively secure the handle to an appliance frame.

In a further embodiment, a vent trim is arranged between the door and the handle.

In another example, the vent trim defines an opening configured to receive the ball.

In a further embodiment, the post is configured to be screwed into the spacer.

In another example, the socket is configured to receive the ball when the handle is at a predefined angle relative to the door.

In a further embodiment, the socket is configured to maintain the ball therein and the handle at a fixed position relative to the door unless a force is applied at the predefined angle.

In another example, the predefined angle is thirty degrees.

In a further embodiment, the socket is formed of a polymer material.

In another example, the socket is formed of Hostaform.

In a further embodiment, the ball is formed of a metal material.

In another example, the ball is formed of steel.

In a further embodiment, the socket is formed of a material that is more malleable than that of the ball.

A handle assembly for an appliance door may include a handle having at least one attachment mechanism extending from a spacer on an unexposed side of the handle, the attachment mechanism including an engagement portion arranged on a post, the post being received and fixed to the spacer, a socket arranged on the appliance door and configured to receive the engagement portion to for form a snap-fit with the engagement portion to selectively secure the handle to an appliance frame, wherein the socket is formed of a material more malleable than the engagement portion, and wherein the socket is configured to receive the engagement portion during installation of the handle on the appliance door when the handle is presented a predefined angle relative to the door.

In another example, the engagement portion is in the shape of a ball, further comprising a vent trim arranged between the door and the handle.

In a further embodiment, the engagement portion is in the shape of a cylinder.

In another example, the post is configured to be screwed into the spacer.

In a further embodiment, the socket is configured to maintain the engagement portion therein and the handle at a fixed position relative to the door unless a force is applied at the predefined angle.

In another example, the predefined angle is thirty degrees.

In a further embodiment, the socket is formed of a polymer material.

In another example, the engagement portion. is formed of a metal material.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example front view of an appliance such as an oven, having a door assembly;

FIG. 2 illustrates an exploded perspective view of the door assembly of FIG. 1; and

FIG. 3 illustrates a side view of another example of the door assembly of FIG. 1.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

Appliances, specifically ovens, include handles to allow a user to open and close the door of the appliance. Often times the appliance door may be shipped with the handle installed, or if uninstalled, requiring the user to install the handle, often via screws. However, should the user desire a different handle, either in style, color, etc., it is very difficult to change out the handle once the handle has been installed. It may further be difficult to package the appliance with the handle pre-installed. Additional costs may be recognized in order to protect the handle and the appliance during shipping. Further, even with special packaging, the handle may become damaged during shipping. Further, damage to the door itself may be appreciated due to the extra load of the handle on the door. This may include dents, glass breakage, etc.

Accordingly, an appliance handle that is easy to install after shipment may be desired. Moreover, traditional handles are difficult to change once installed. Should a user desire a different handle style, color, etc., the user may desire an easily interchangeable handle. The handle may be changed frequently, such as seasonally, to reflect holiday or special occasion decor, or may be updated and changed more sporadically, for example, when a room is renovated or remodeled. Regardless, having an easily changeable handle would benefit the user, save on shipping and replacement costs, and increase the overall satisfaction of the appliance. While an oven is described herein, this is merely exemplary and other appliances may be contemplated such as a refrigerator, microwave oven, dishwasher, as well as small appliance such as toaster ovens, to name some examples.

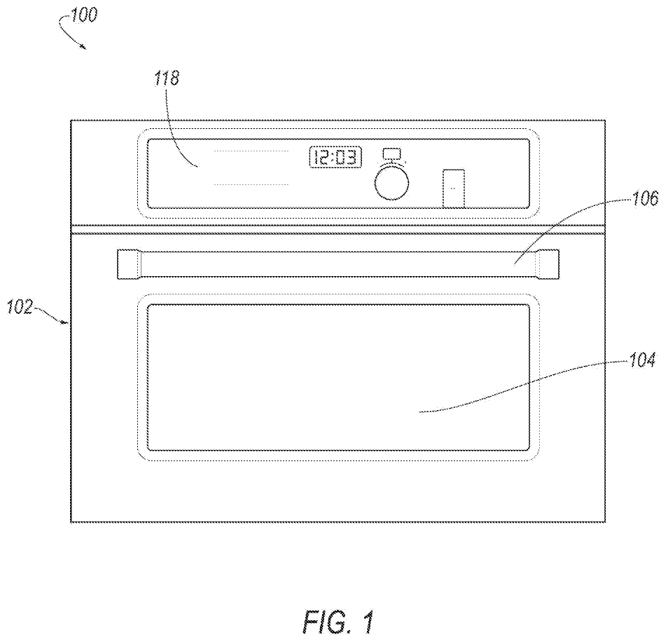

FIG. 1 illustrates an example front view of an appliance such as an oven 100, having a door assembly 102, also referred to as the door 102. The oven 100 may be one of various cooking appliances, such as a conventional oven, a convection oven, a conduction oven, a microwave oven, a toaster oven. In some examples, the smart oven 100 may be a function-specific oven, such as a roaster oven, a pizza oven, etc. The smart oven 100 may be a standalone oven in some cases, while in other cases the oven may be built-in or a component of a combination oven and stove top.

The oven 100 may form a cabinet and define a cavity (not shown) having a cavity top, cavity bottom, cavity back, and side walls. The door assembly 102 may be hinged at a front of the cavity to permit access to the cavity. The door assembly 102 may include a window 104 and a handle 106 and may hermetically seal the cavity when the door is in a closed position. It should be noted that this is an example, and ovens 100 with different types of doors may be used. For instance, a door may be hinged at a side instead of the bottom, as illustrated in FIG. 1. A door sensor may be arranged on the door or the cavity to detect an open and closed position of the door of the door assembly 102.

The cavity may be configured to receive food items for cooking, baking, and/or broiling during a cooking cycle. In some examples, the cavity may also include temperature sensors for determining the air temperature within the cavity during cooking. The oven 100 may further include a user interface 118 configured to receive user input with respect to cycles or other oven operation. The user interface 118 may also provide information to the user such as cook time, temperature, etc.

The oven 100 may include a heating system (not shown) for heating the cavity during cooking. The heating system may include one or more heating elements, such as a gas heating element or an electric heating element. In one example, the heating system may include a first heating element at the bottom of the cavity, and a second heating element at the top of the cavity. In yet a further example, heating elements may be arranged between the cabinet and the cavity back and/or the cavity top. The oven may also include one or more racks within the cavity for supporting the food items during cooking.

The handle 106 may be configured to be attached to the door assembly 102 by the user after the appliance has been installed, or at least after being shipped and received by the user. The handle 106 may be an elongated grip or bar configured to extend across a substantial portion of the appliance door assembly 102. However, other example configurations may be contemplated. The handle 106 may be interchangeable and easily removed and installed on the door assembly 102. In the examples shown, the handle 106 may attach to the door assembly 102 at two locations, typically at each distal end of the handle 106. However, other attachment locations may be appreciated, such as a single, central location, two locations inset from the distal ends, etc.

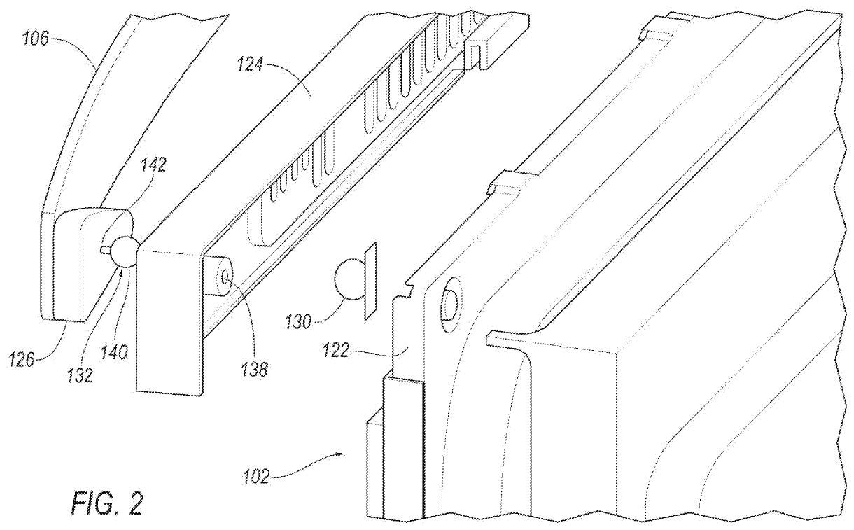

FIG. 2 illustrates an exploded perspective view of the door assembly 102 of FIG. 1. The door assembly 102 may create a seal with an appliance frame 122 configured to form the opening to the oven cavity. A vent trim 124 may be arranged and secured to the door assembly 102. The vent trim 124 may from a protective layer over an exhaust or vent portion of the oven 100 so as to protect the exhaust area from debris, as well as prevent existential contact of the exhaust area with the user. The vent trim 124 may extend across the top of the door assembly 102, as shown in FIG. 2. However, the vent trim 124 may extend across other portions of the door assembly 102 as well. In an example where the door assembly 102 is attached to the frame at the bottom, the vent trim 124 may be arranged at the top, opposite the hinge and behind the handle 106.

The vent trim 124 may define at least one opening 138 to allow connecting mechanisms to pass between the handle 106 and the appliance frame 122 to allow the handle 106 to attach to the door assembly 102 during installation. In some instances, the handle 106 may be attached to the door assembly 102 using screws extending from the back side of the door assembly 102 and being screwed into the backside of the handle 106 to attach the handle 106 to the frame 122. This may be done at production, or afterwards by the customer.

The handle 106 is arranged on top of the vent trim 124. The user may pull on the handle 106, allowing the door assembly 102 to hinge at the bottom and open the door assembly 102 to allow access to the oven cavity. In other examples, the door assembly 102 may hinge at one side of the frame 122, with the handle 106 and vent trim 124 being located at the opposite side. The handle 106 may have a generally curved shape where the center of the handle 106 is furthest from the vent trim 126, creating an opening between the backside of the handle 106 and the vent trim 126. However, the handle 106 may be other shapes, having no curvature, more than one curvature, etc.

A spacer 128 may be arranged at each end of the handle 106. The spacer 128 may be arranged between the handle 106 and the vent trim 126. The spacer 128 may be integrated with the handle 106 or may be a separate piece attached to the handle 106 via a screw or other attachment mechanism. The spacer 128 may aid in creating a larger space between the handle 106 and the vent trim 126 to allow a user to more easily access and engage the handle 106. The spacer 128 may be a triangular shape having at least one flat side aligning with the end of the handle 106. The spacer 128 not be visible from the front of the appliance.

An attachment mechanism 132 may be arranged on the spacer 128. The attachment mechanism 132 may extend outward from the spacer 128 and may, in an example, be a steel headed threaded attachment configured to be screwed into a threaded opening in the spacer 128. The attachment mechanism 132 may also be formed of other materials such as plastic, resin, etc. The attachment mechanism 132 may include an engagement portion 140, also referred to herein as attached to a threaded post 142. The ball 140 may extend outward from the spacer 128 once the post 142 is screwed into the threaded opening in the spacer 128. Other attachment mechanisms besides a threaded engagement may be used to adhere the ball 140 to the spacer 128. Although not shown, a second attachment mechanism 132 may be arranged on the opposite spacer on the other side of the handle 106. While the engagement portion 140 is referred to herein specifically as ball 140 and cylinder 140, or shapes may be contemplated and these are merely examples.

At least one socket 130 may be arranged on the appliance frame 122. In the example shown in FIG. 2, the socket 130 is arranged at the top corner of the appliance frame 122. Although not shown, a second socket 130 is arranged at the opposite corner of the appliance frame 122. The socket 130 may form a spherical shape having an opening at one side to receive the ball 140 of the attachment mechanism 132. The socket 130 may allow for a snap-fit with the attachment mechanism 132.

The socket 130 may be attached to the appliance frame 122 during manufacturing and may be configured to align with the placement of the attachment mechanisms 132 on the handle 106. The socket 130 may be configured to receive the ball 140 at a predefined angle in order to snap the ball 140 into the socket 130. For example, a thirty degree offset from a parallel plane. Further, the angle for disengaging the ball 140 from the socket may be similar. This is just an example angle and other predefines angles may be appreciated.

The insertion angle makes it easy for the handle 106 to be tilted to the angle and then snaped into place. Once the handle 106 is installed on the door assembly 102, the user may push and pull on the handle 106. The ball 140 and socket 130 engagement may maintain the handle 106 in fixed relationship with the door during normal operation, e.g., opening and closing, of the door assembly 102. However, the handle 106 may also be selectively removed from the door assembly 102. This may be desired to change the handle 106 for color, or other aesthetic reasons. To do this, additional force, at a predefined angle, such as the same angle as the angle used to install the handle 106, may be required to un-snap the ball 140 from the socket 130. By requiring the specific angle, inadvertent removal of the handle 106 is avoided during normal use of the handle 106. That is, the ball 140 and socket 130 properties and configuration prevent such unintended removal and provided for a secure handle 106 during normal use, but also allow for the flexibility to easily change the handle 106. Notably, the changing of the handle 106 does not require any adjustments at or behind the door assembly 102, increasing the ease of use.

Further, additional tools or specific service calls are not required to change the handle 106. Instead, customers can change the handle 106 as desired and without uninstalling the appliance, removing the door, etc. The handle 106, as well as the appliance, have a lower risk of being damaged during shipment and delivery. Packaging costs may also be reduced, in addition to production costs, assembly line timing, handling of additional parts, etc.

The socket 130 may be formed of a polymer having a rigid and linear structure that provides for long wear, long-term fatigue, toughness, and resistance, while also resisting moisture. In one example, Hostaform, such as Hostaform C 9021 may be used. The polymer material may also be resistant to heat, which is especially important when the appliance is a cooking device that could radiate heat. Other example properties of the socket 130 may include a retaining angle of seventy degrees, and an outer diameter of 24 mm. The socket 130 may have a tensile strength of 4 N/mm2, a max undercut depth of 0.16 mm, an undercut diameter of 15.84 mm, an undercut width of 0.139 mm. Further, the assembly force may be 145.18 N, retaining force of 498.51 N, among other properties.

The shaft of the attachment mechanism 132 may be approximately 16 mm, in one example. The attachment mechanism 132 may be a less mailable material than that of the socket 130, for example, the attachment mechanism 132 may be of a metal material, specifically steel.

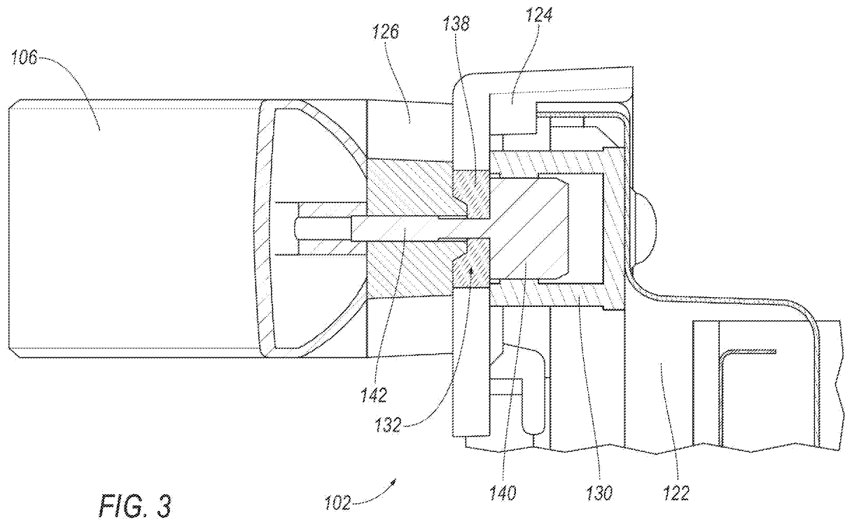

FIG. 3 illustrates a side view of another example of the door assembly of FIG. 1. As explained above, the door assembly 102 may create a seal with the appliance frame 122 and configured to form the opening to the oven cavity. The vent trim 124 may be arranged and secured to the door assembly 102. The vent trim 124 may define the at least one opening 138 to allow connecting mechanisms to pass between the handle 106 and the appliance frame 122 to allow the handle 106 to attach to the door assembly 102 during installation.

A spacer 126 may be arranged at each end of the handle 106. The spacer 126 may be arranged between the handle 106 and the vent trim 124. The spacer 126 may be integrated with the handle 106 or may be a separate piece attached to the handle 106 via a screw or other attachment mechanism. The spacer 126 may aid in creating a larger space between the handle 106 and the vent trim 126 to allow a user to more easily access and engage the handle 106.

An attachment mechanism 132 may be arranged on the spacer 128. The attachment mechanism 132 may extend outward from the spacer 128 and may, in an example, be a steel headed threaded attachment configured to be screwed into a threaded opening in the spacer 128. The attachment mechanism 132 may also be formed of other materials such as plastic, resin, etc. In the example of FIG. 3, the attachment mechanism 132 may include a cylinder or any other shape attached to a threaded post 142. The cylinder 140 may extend outward from the spacer 128 once the post 142 is screwed into the threaded opening in the spacer 128. Other attachment mechanisms besides a threaded engagement may be used to adhere the cylinder 140 to the spacer 128. Although not shown, a second attachment mechanism 132 may be arranged on the opposite spacer on the other side of the handle 106.

At least one socket 130 may be arranged on the appliance frame 122. The socket 130 may mimic the cylindrical or spherical shape of the attachment mechanism 132 and may allow for a snap-fit with the attachment mechanism 132.

The socket 130 may be attached to the appliance frame 122 during manufacturing and may be configured to align with the placement of the attachment mechanisms 132 on the handle 106. Similar to FIG. 2, the socket 130 may be configured to receive the cylinder 140 at a predefined angle in order to snap the cylinder 140 into the socket 130.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A handle assembly for an appliance door, comprising:
a handle having at least one attachment mechanism extending from a spacer on an unexposed side of the handle, the attachment mechanism including a ball arranged on a post, the post being received and fixed to the spacer; and
a socket arranged on the appliance door and configured to receive the ball to selectively secure the handle to an appliance frame.

2. The assembly of claim 1, further comprising a vent trim arranged between the door and the handle.

3. The assembly of claim 2, wherein the vent trim defines an opening configured to receive the ball.

4. The assembly of claim 1, wherein the post is configured to be screwed into the spacer.

5. The assembly of claim 1, wherein the socket is configured to receive the ball when the handle is at a predefined angle relative to the door.

6. The assembly of claim 5, wherein the socket is configured to maintain the ball therein and the handle at a fixed position relative to the door unless a force is applied at the predefined angle.

7. The assembly of claim 6, wherein the predefined angle is thirty degrees.

8. The assembly of claim 1, wherein the socket is formed of a polymer material.

9. The assembly of claim 1, wherein the socket is formed of Hostaform.

10. The assembly of claim 1, wherein the ball is formed of a metal material.

11. The assembly of claim 1, wherein the ball is formed of steel.

12. The assembly of claim 1, wherein the socket is formed of a material that is more malleable than that of the ball.

13. A handle assembly for an appliance door, comprising:
a handle having at least one attachment mechanism extending from a spacer on an unexposed side of the handle, the attachment mechanism including an engagement portion arranged on a post, the post being received and fixed to the spacer; and
a socket arranged on the appliance door and configured to receive the engagement portion to for form a snap-fit with the engagement portion to selectively secure the handle to an appliance frame, wherein the socket is formed of a material more malleable than the engagement portion, and wherein the socket is configured to receive the engagement portion during installation of the handle on the appliance door when the handle is presented a predefined angle relative to the door.

14. The assembly of claim 13, wherein the engagement portion is in the shape of a ball.

15. The assembly of claim 13, wherein the engagement portion is in the shape of a cylinder.

16. The assembly of claim 13, wherein the post is configured to be screwed into the spacer.

17. The assembly of claim 16, wherein the socket is configured to maintain the engagement portion therein and the handle at a fixed position relative to the door unless a force is applied at the predefined angle.

18. The assembly of claim 13, wherein the predefined angle is thirty degrees.

19. The assembly of claim 13, wherein the socket is formed of a polymer material.

20. The assembly of claim 13, wherein the engagement portion ball is formed of a metal material.
